(19) United States
(12) Patent Application Publication
(10) Pub. No.: US 2007/0149751 A1
(43) Pub. Date: Jun. 28, 2007

(54) Bulk manufacturing of supramolecular polymer forming polymer

(76) Inventors: Christopher Ian Lindsay, Overijse (BE); Steve Andre Woutters, Beveren (BE)

Correspondence Address: Huntsman Corporation;Legal Department, Waterway One, 10003 Woodloch Forest Drive, The Woodlands, TX, 77380, US

(21) Appl. No.: 11/638,910

(22) Filed: Dec. 14, 2006

Related U.S. Application Data
(63) Continuation-in-part of application No. 10/444,612, filed on May 23, 2003, now abandoned.
Application No. 10/444,612 is a continuation of application No. PCT/EP01/14082, filed on Mar. 12, 2001.

(30) Foreign Application Priority Data
May 12, 2000 (EP) 00126685.7

(51) Int. Cl. C08G 18/00

(52) U.S. Cl. 528/62

(57) ABSTRACT

A polymer having the following general formula: 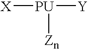 where, PU is a polymer chain comprising at least one polyurethane chain; n ranges from 0 to 8; and X, Y and Z, identical or different, are H-bonding sites. Also provided is a supramolecular polymer comprising units that form H-bonds with one another, wherein at least one of these units is a polymer according to the invention. The supramolecular polymer is useful as a hot melt adhesive, in rotational or slush molding, in injection molding, and in the manufacture of thermoplastic polyurethane foams. Further provided is a process for the preparation of the polymer on bench and commercial scales.

### CROSS REFERENCE TO RELATED APPLICATIONS

This application is a continuation-in-part of patent application Ser. No. 10/444,612, which is a continuation of international application PCT EP01/14082, filed Dec. 3, 2001.

### FIELD OF THE INVENTION

This invention relates to a polymer that is able to form a supramolecular polymer, to the preparation of such a polymer on bench and commercial scale, and to the uses of the formed supramolecular polymer.

### BACKGROUND OF THE INVENTION

It has been known for several years that supramolecular polymers are polymers in which the monomers are at least in part bonded to one another via H-bridges. When the monomer units have a low molecular weight, they form at low temperature a rigid dimensionally stable polymer. At higher temperatures, however, because the H-bridges are much weaker, essentially only monomeric units are present and can be easily handled.

The prior art, for example, discloses a supramolecular polymer containing monomeric units that form H-bridges with one another, the H-bridge-forming monomeric units in pairs forming at least 4-H-bridges with one another. As H-bridge-forming monomeric units, substituted ureido-pyrimidones and ureido-pyrimidines were used (see e.g. International Patent Application No. WO 97/46607 and its U.S. equivalent, U.S. Pat. No. 6,114,415). Such prior art discusses the end-capping of polydimethyltrisiloxanes with 4-benzyloxy-6-(3-butenyl)-2-butylureidopyrimidine and 6-(3-butenyl)-2-butylureido-4-pyrimidone, respectively.

The prior art also discusses the reaction of 6-tridecylisocytosine with hexanediisocyanate to give a bifunctional compound that forms reversible polymers (see e.g. “Reversible Polymers Formed from Self-Complementary Monomers Using Quadruple Hydrogen Bonding”, by R. P. Sijbesma, H. B. Beijer, L. Brunsveld, B. J. B. Folmer, J. H. K. Ky Hirschberg, R. F. M. Lange, J. K. L. Lowe, E. W. Meijer, published in Science, Vol. 278, 28 Nov. 1997). Also discussed in the prior art is the functionalization of a trifunctional copolymer of propylene oxide and ethylene oxide with a diisocyanate, followed by a reaction with methylisocytosine to give a compound that has the ability to form reversible polymer networks. These compounds are supposed to allow the formation of polymer networks that can be used in hot melts and coatings. However, one compound has a tendency to crystallize and the other exhibits poor mechanical properties.

The prior art further discusses the end-capping of hydroxy terminated polymers with a reactive synthon obtained by the reaction of methylisocytosine with 1,6-hexanediisocyanate (see e.g. “New Polymers Based on the Quadruple Hydrogen Bonding Motif”, by Brigitte J. B. Folmer, pages 91-108, PhD Thesis, Technische Universiteit Eindhoven, 2000 (in particular page 96)). The hydroxy terminated polymers are a hydrogenated polybutadiene, a polyether, a polycarbonate and a polyester.

### SUMMARY OF THE INVENTION

An object of this invention is therefore to provide a process for the production of a supramolecular polymer. The process comprising mixing at least one polyol, a chain extender, a diisocyante, an amino-functional organic powder, and optionally a catalyst to form a mixture. The process further comprises heating the mixture to a temperature between about 100° C. and about 250° C.

Other objects, features, and advantages will become more apparent after referring to the following specification.

### DETAILED DESCRIPTION

The polymer of the invention has the following general formula: 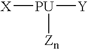
where, PU is a polymer chain comprising at least one polyurethane chain;
n ranges from 0 to 2; and
X, Y and Z are identical or different and are H-bonding sites.
   Polyurethane Chain PU

According to the invention, the polymer chain PU comprises at least one polyurethane chain. According to one embodiment, the PU is thermoplastic, elastomeric, or a combination thereof. According to another embodiment, the polyurethane chain preferably comprises at least one soft block and at least two hard blocks. The soft and hard blocks are according to the common general knowledge in the art.

The polyurethane chain may have a molecular weight (MWn) ranging between large limits. The molecular weight is calculated according to the Dryadd Pro model (1998, Oxford Materials Ltd, UK). It generally has a low average molecular weight (i.e. an average molecular weight of less than 100,000). Preferably, the average molecular weight is in the range of 10,000 to 50,000. Alternatively, the average molecular weight is between 10,000 and 25,000.

This PU chain is obtained by classical methods known in the art (see, for example, Poyurethanes Handbook 2^{nd} edition, G. Oertel, 1994). The chains are notably obtained by the reaction of an isocyanate, an isocyanate-reactive compound (i.e. a polyol), and a chain extender.

For example, the suitable organic polyisocyanates for use in the process of the present invention include any of those known in the art for the preparation of polyurethanes. In particular, the aromatic polyisocyanates, such as diphenylmethane diisocyanate in the form of its 2,4′-, 2,2′- and 4,4′-isomers and mixtures thereof, the mixtures of diphenylmethane diisocyanates (MDI), and oligomers thereof known in the art as “crude” or polymeric MDI (polymethylene polyphenylene polyisocyanates) having an isocyanate functionality of greater than 2 may be used. Although these are not preferred, toluene diisocyanate, in the form of its 2,4- and 2,6-isomers and mixtures thereof, 1,5-naphthalene diisocyanate and 1,4-diisocyanatobenzene may also be used. Other organic polyisocyanates that may be used include the aliphatic diisocyanates, such as isophorone diisocyanate, 1,6-diisocyanatohexane and 4,4′-diisocyanatodicyclo-hexylmethane. aliphatic isocyanates. Most preferred is MDI, especially 4,4′-MDI. The functionality is preferably 2. Mixtures may be used.

Suitable isocyanate-reactive compounds to be used in the process of the present invention include any of those known in the art for the preparation of polyurethanes. Of particular importance are polyols and polyol mixtures having average hydroxyl numbers of from 20 to 300, especially from 25 to 150 mg KOH/g, and hydroxyl functionalities of from 1.5 to 3, especially from 1.8 to 2.2, and a molecular weight generally from 750 to 6000. Suitable polyols include polyether diol products obtained by the polymerization of a cyclic oxide, for example ethylene oxide, propylene oxide, butylene oxide or tetrahydrofuran in the presence, where necessary, of difunctional initiators. Suitable initiator compounds contain 2 active hydrogen atoms and include water, butanediol, ethylene glycol, propylene glycol, diethylene glycol, triethylene glycol, dipropylene glycol, 1,3-propane diol, neopentyl glycol, 1,4-butanediol, 1,5-pentanediol, 2-methyl-1,3-propanediol, 1,6-pentanediol and the like. Mixtures of initiators and/or cyclic oxides may be used. Other suitable polymeric polyols include polyesters obtained by the condensation of appropriate proportions of glycols and higher functionality polyols with dicarboxylic or polycarboxylic acids. Still further suitable polymeric polyols include hydroxyl terminated polythioethers, polyamides, polyesteramides, polycarbonates, polyacetals, polyolefins and polysiloxanes. The isocyanate-reactive compound is preferably a polyol that is preferably a polyether or a polyester or mixtures thereof. Mixtures may be used.

A chain extender is classically used. It is traditionally a low molecular weight polyol, typically a diol. The molecular weight generally ranges from 62 to 750, and the functionality generally ranges from 1.9 to 2.1. Examples of suitable diols include ethylene glycol, diethylene glycol, butanediol, triethylene glycol, tripropylene glycol, 2-hydroxyethyl-2′-hydroxypropylether, 1,2-propylene glycol, 1,3-propylene glycol, PRIPOL® diol(commercially available from Uniquema, Gouda, NL), dipropyl glycol, 1,2-, 1,3- and 1,4-butylene glycols, 1,5-pentane diol, bis-2-hydroxypropyl sulphide, bis-2-hydroxyalkyl carbonates, p-xylylene glycol, 4-hydroxymethyl-2,6-dimethyl phenol and 1,2-, 1,3- and 1,4-dihydroxy benzenes. PEG, PPG (e.g. 200) as well as PTHF (also known as PTMG) (e.g. 400) may also be used. Mixtures may be used.

The quantities of the polyisocyanate compositions and the polyfunctional isocyanate-reactive compositions as well as those of the chain extender to be reacted (in the absence of end-cap monomer) will depend upon the nature of the polyurethane to be produced and will be readily determined by those skilled in the art. The isocyanate index can vary within broad limits, such as between 90 and 150, and preferably between 90 and 120.

H-Bonding Groups

According to the invention, the polymer chain PU bears the H-bonding groups X and Y, and optionally Z, which are identical or different. Preferably, X and Y are identical and are the end groups of the polymer chain PU.

Generally, the H-bonding groups X and Y (and Z) have at least two sites capable of H-donor capability and at least two sites capable of H-acceptor capability (where these two sites may not be fully reacted). The H-donor site may be a H-donor group well known by those skilled in the art. Such an H-donor group may comprise —NH—, —OH or —SH groups. The H-acceptor site may be a H-acceptor site well known by those skilled in the art. Such an H-acceptor site may comprise atoms like O, N or S. According to one embodiment of the invention, X and Y (and Z) includes the group —NH—CO—NH—.

According to one embodiment, X and Y are obtained by the reaction of a terminal isocyanate group with a compound of formula H₂N—R₁R₂, where R₁ and R₂ are each independently a C1-C6 alkyl or C3-C6 cycloalkyl group, or together can form a ring having one or two cycle(s), one or both of R₁ and R₂ being optionally interrupted by one or more heteroatom(s) selected from N, O and S.

The amine can be of formula H₂N—C(R₃)═N—R₄, where R₃ and R₄ are each independently a C1-C6 alkyl or C3-C6 cycloalkyl group, or together can form a ring having one or two cycle(s), one or both of R₃ and R₄ being optionally interrupted by one or more heteroatom(s) selected from N, O and S.

Preferably, at least one of R₁ and R₂ or R₃ and R₄ respectively is interrupted by one or more heteroatom(s).

Preferably, the amine is of formula: 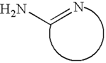
where the curve is a ring having one or two cycles, optionally interrupted by one or two heteroatoms selected from N, O and S. The molecular weight is preferably below 400. Preferably, the H-bonding site of the compound A reacting with the —NCO group is adjacent to the group that reacts with the —NCO group of the polymer.

The amine can be selected from the group consisting of 2-aminopyrimidine, isocytosine, 6-alkylisocytosine such as 6-methylisocytosine, 2-aminopyridine, 5-amino-uracil 6-tridecylisocytosine, 6-phenyl-isocytosine, 2-amino-6-(3-butenyl)-4-pyrimidone, p-di-(2-amino-6-ethyl-4-pyrimidone)benzene, 2-amino 4-pyridone, 4-pyrimidone 6-methyl-2-amino-4-pyrimidone, 6-ethyl-2-amino-4-pyrimidone, 6-phenyl-2-amino-4-pyrimidone, 6-(p-nitrophenyl)isocytosine, 6-(trifluoromethyl)isocytosine and their mixtures. Examples of such compounds are 2-aminopyrimidine, 5-aminouracil, isocytosine and 6-alkylisocytosine such as 6-methylisocytosine. The preferred amines are 2-aminopyrimidine and 6-alkylisocytosine such as 6-methylisocytosine.

The weight percentage of the groups X and Y based on the weight of the entire polymer of the invention generally ranges from 0.5 to 10%, preferably 0.5 to 5%, more preferably 0.5 to 2.5%.

For example, one can cite as amine compounds the following compounds: 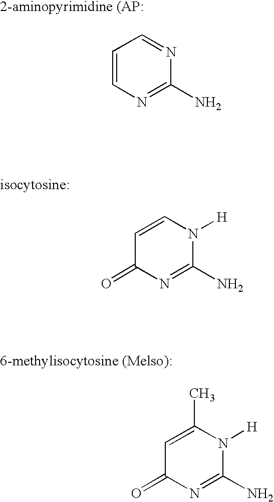
A Process of Making the Polymers

The polymer of the invention may be prepared according to a process comprising the step of reacting a polymer comprising at least one polyurethane chain and at least two free —NCO groups with at least one compound A having at least one group able to react a —NCO group and at least one H-bonding site. This compound A is described above.

2-aminopyrimidine is one of the preferred reactants because its melting point is quite low, about 125° C. This is interesting from a production viewpoint because it allows one to prepare the polymer of the invention at lower temperatures. 6-alkylisocytosine, such as 6-methylisocytosine, is one of the preferred reactants because of the powerful effect (i.e. the resulting (supra)polymer exhibits high mechanical properties with low viscosities at melt).

A preferred process is one in which the polymers are obtained by reacting a polyisocyanate (1) with a functionality of 2, a polyol (2) having a MW from 750 to 6000 and a functionality from 1.8 to 2.2, a polyol (3) having a MW from 62 to 750 with a functionality of 1.9 to 2.1 and an amine compound (4) of formula H₂N—C(R₃)═N—R₄, where R3 and R4 are each independently a C1-C6 alkyl or C3-C6 cycloalkyl group, or together can form a ring having one or two cycle(s), all being optionally interrupted by one or more heteroatom(s) selected from N, O and S, with a MW less than 400 wherein the amount of isocyanate (1), polyol (2), polyol (3) and amine (4) is 10-50, 35-90, 1-30 and 0.5-20 by weight respectively per 100 parts by weight of isocyanate (1), polyol (2), polyol (3) and amine (4) wherein the reaction is conducted at an isocyanate index of 90 to 200, preferably 95 to 150, especially 98 to 102.

The above index also applies to any general process involving the reaction of polyisocyanate compositions, polyfunctional isocyanate-reactive compositions, chain extender and end-cap monomer (or compound A).

Supramolecular Polymers

Thanks to its H-bonding groups X and Y, the polymer of the invention has the ability to allow the formation of a supramolecular polymer at room temperature. This is represented below, with isocytosine as an example. The dotted lines represent the H-bonds.

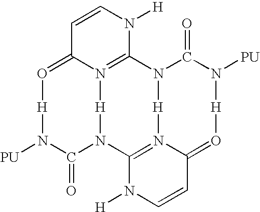

Therefore, an object of the invention is also a supramolecular polymer comprising units that form H-bridges with one another, and in which at least one of these units is a polymer according to the invention as described above. The remaining units can be different units, for example, units as described in International Patent Application No. WO 97/46607. Preferably, the units are the same.

In the polymer of the invention, the groups X and Y generate thermoreversible linear chain extension through H-bonding interactions. Thus, the units have the capability to auto chain extend by chain-end interaction through H-bonding interaction. Because the H bonds are thermoreversible, at low temperatures, the H-bond interaction is high and the supramolecular polymer has an apparent high molecular weight. At high temperatures, the H-bond interaction does not exist anymore or is low and the supramolecular polymer mainly decomposes into its monomeric units and behaves as a low molecular weight polymer. In other words, when heated, the hydrogen bonds break and give a low viscosity material. Therefore, the supramolecular polymer has pseudo-high molecular weight properties at room temperature but low molecular weight properties at melt.

Commercial Production of Supramolecular Polymers

The inventive polymers may be commercially produced via a bulk process. A bulk process is one wherein a minor amount of solvent is present, i.e., less than about 50%, preferably less than about 10%, more preferably less than about 5%, more preferably less than about 1%, most preferably less than about 0.5% solvent, by total weight of the components, is present. The commercial process preferably includes incorporating an amino-functional organic powder into a mixture of isocyanate, polyol(s), and chain extender. In an alternative embodiment, the mixture also includes catalyst. Suitable catalysts are generally known in the art, and include tin compounds, such as a tin salt of a carboxylic acid, for example dibutyltin dilaurate, stannous acetate and stannous octoate; amines, such as dimethylcyclohexylamine and triethylene diamine; and preferably bismuth sulphate. The amino-functional organic powder may be added before the mixture is polymerized; however, it is most preferably all of the components, including the amino-functional organic powder, are added at about the same time.

Polymerization may be carried out within the chambers of an internal mixer. Suitable mixers include Banbury RTM type mixers, including a Brabender Plasticord internal mixer, or twin-screw extruders, including a Berstorff 25 mm twin-screw extruder. The reaction temperature, i.e., the temperature of the vessel prior to the introduction of the reaction components, is preferably greater than about 100° C., preferably between about 150 to about 230° C., alternatively about 180° C., alternatively between about 180 to about 230° C., alternatively greater than about 230° C., alternatively greater than about 250° C., alternatively between about 100° C. and about 250° C. Accordingly, preferred amino-functional organic powders have melting temperatures greater than about 100° C. Additionally, in a preferred embodiment, the solid to liquid transition occurs at temperatures greater than about 100° C.

The amino-functional organic powder may be 6-methylisocytosine having the following general structure: 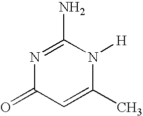
Preferably, the amino-functional organic powder is milled to a particle size suitable to facilitate rapid and efficient reaction. In an embodiment, the average particle size of the amino-functional organic powder is less than about 500 microns, preferably less than about 100 microns, preferably less than about 51 microns, preferably less than about 50 microns, preferably less than about 40 microns, preferably less than about 30 microns, preferably less than about 20 microns, preferably less than about 15 microns, and most preferably less than about 10 microns. In another embodiment, 97% of the amino-functional organic powder has an average particle size less than preferably less than about 500 microns, preferably less than about 100 microns, preferably less than about 51 microns, preferably less than about 50 microns, preferably less than about 40 microns, preferably less than about 30 microns, preferably less than about 20 microns, preferably less than about 15 microns, and most preferably less than about 10 microns. In a further embodiment, 75% of the amino-functional organic powder has an average particle size less than preferably less than about 100 microns, preferably less than about 51 microns, preferably less than about 50 microns, preferably less than about 40 microns, preferably less than about 30 microns, preferably less than about 20 microns, preferably less than about 15 microns, and most preferably less than about 10 microns.

If an amino-functional organic powder is present, it is present in an amount ranging from about 0.05 to about 5 weight percent, based on the total weight of the mixture. Alternatively, the amino-functional organic powder is present in an amount from about 0.05 to about 2.5, preferably from about 0.5 to about 2, alternatively from about 0.5 to about 1.5, alternatively form about 0.5 to about 1.0 weight percent, based on the total weight of the mixture.

Preferably, following reaction, the conversion mole percent of the amino-functional organic powder is between about 40 to about 100 percent, preferably between about 50 to about 100 percent, preferably between about 60 to about 100 percent, preferably between about 70 to about 100 percent, preferably between about 80 to about 100 percent, preferably between about 90 to about 100 percent, most preferably between about 95 to about 100 percent, alternatively from about 75 to about 95 percent.

Uses of Supramolecular Polymer

The supramolecular polymer of the invention can generally be used in all applications where the PUs (such as those forming the PU chain) are used. Hot melts adhesive is one of the preferred applications. In this case, a unique feature of the supramolecular polymer of the invention is that it provides an adhesive having no unreacted NCO group (unlike reactive hot-melts that require water to fully cure). This is also an advantage in terms of safety and handling. Another unique feature of the supramolecular polymer of the invention is that it does not require solvent, unlike known solvent-borne TPU adhesives. Another advantage provided by the supramolecular polymer of the invention is that it does not need moisture to reach ultimate mechanical properties. As such, it can be used in adhesive applications of non-moisture permeable substrates like Al—Al joints. A further application is film adhesives where the low melt viscosity of the polymers can enhance wetting and adhesion to substrates.

Another application is rotational and/or slush molding. Because fluidity is very high under the conditions used, ensuring a good spread in the mold is required. Still another application is injection molding and the manufacture of TPU foams.

The main advantage of the supramolecular polymers is their lower viscosity at melt than the uncapped ones (which do not form supramolecular polymers). This allows easier processing, while retaining good mechanical properties at room temperature. To evaluate their efficiency, the properties were plotted versus viscosity at melt, because an increase in melt viscosity corresponds to an increase in the molecular weight.

The following examples are illustrative of the present invention, and are not intended to limit the scope of the invention in any way.

### EXAMPLES

### Example 1

Prepolymer 1 was prepared by stirring a mixture of 73 pbw of a polypropyleneoxide (PPG2000) having a nominal functionality of 2 and nominal MW 2000 together with 27 pbw SUPRASEC® MPR isocyanate at 87° C. under nitrogen for three hours. After cooling, the prepolymer was stored as a masterbatch under nitrogen.

A pre-calculated amount of 1,4-butanediol BD ( 50wt % solution in dimethylacetamide) was added dropwise over a period of 20 minutes to a known amount of a stirred 50wt % dimethylacetamide solution of the prepolymer at 87° C. under nitrogen and the heating/stirring were maintained for a further 3 hours. A dimethylacetamide solution of the desired end-capping compound was added to the stirred reaction mixture at 87° C. and the reaction conditions were maintained for a further 3 hours. After cooling, the TPU or TRPU was isolated by casting at 50° C. in a vacuum oven or by precipitation of a 30wt % dimethylacetamide solution into a four-fold (by mass) excess of a non-solvent (80vol % water/20vol % ethanol). The formulations of the resultant TPUs and TRPUs are given in Table 1.

TABLE 1

| | End-Capping | pbw | | pbw End |
|---|---|---|---|---|
| Sample | Compound | Prepol. 1 | pbw BD | Group |
| 1A1 | isocytosine | 92.5 | 5 | 2.5 |
| 1A2 | isocytosine | 93.0 | 5.5 | 1.5 |
| 1A3 | isocytosine | 93.1 | 5.9 | 1.0 |
| 1B1 | 6-methyl | 93.0 | 5.0 | 2.0 |
| | isocytosine | | | |
| 1B2 | 6-methyl | 92.65 | 5.5 | 1.85 |
| | isocytosine | | | |
| 1B3 | 6-methyl | 92.6 | 5.9 | 1.5 |
| | isocytosine | | | |
| 1C1 | 2-amino | 92.2 | 4.9 | 2.9 |
| | pyrimidine | | | |
| 1C2 | 2-amino | 92.2 | 5.5 | 2.3 |
| | pyrimidine | | | |
| 1C3 | 2-amino | 92.2 | 5.9 | 1.9 |
| | pyrimidine | | | |
| 1D1 | ethoxyethoxy- | 88.2 | 4.7 | 7.1 |
| | ethanol | | | |
| 1D2 | ethoxyethoxy- | 88.9 | 5.3 | 5.8 |
| | ethanol | | | |
| 1D3 | ethoxyethoxy- | 89.9 | 5.7 | 4.4 |
| | ethanol | | | |
| 1D4 | ethoxyethoxy- | 90.7 | 6.3 | 3.0 |
| | ethanol | | | |
| 1E | None | 92.6 | 7.4 | 0 |

Tensile testing was performed at ambient temperature and a cross-head speed of 100 mm/minute on compression-moulded tensile specimens of type S2 (norm DIN53504; 2 mm thickness). The results of these tests are recorded in Table 2 (at ambient temperature).

TABLE 2

| | Tensile | % Elongation at |
|---|---|---|
| Sample | Strength (Mpa) | Break |
| 1A1 | 2.66 | 487 |
| 1A2 | 3.98 | 655 |
| 1A3 | 7.41 | 760 |
| 1B1 | 2.32 | 308 |
| 1B2 | 4.20 | 618 |
| 1B3 | 7.15 | 705 |
| 1C1 | 1.51 | 124 |
| 1C2 | 2.45 | 211 |
| 1C3 | 3.10 | 278 |
| 1D1 | — | — |
| 1D2 | 1.15 | 58 |
| 1D3 | 1.77 | 153 |
| 1D4 | 2.73 | 212 |
| 1^{E} | 5.41 | 553 |

Rheology

The rheological performance of the TPUs was assessed by Rotational Dynamic Shear (RDS) experiments using a Rheometrics RMS800 rheometer. More precisely, RDS rheometry was used to determine the melting behavior and the viscoelastic behavior of the TPUs in the molten state. The experiments were carried out in the following way. First, a solvent casting (0.5 mm thick) was prepared by dissolving each TPU in DMAc to give approximately a 25 w/w % solution. 160 g of the solution was then degassed and poured into a flat glass mould in a cool oven. The solvent was then removed by leaving the casting in the oven at 80° C. for 24 hours. Then, two 25 mm diameter discs were cut from the solvent casting and inserted under a slight normal pressure between two 25 mm diameter parallel plates to give a 1 mm-thick specimen. Each experiment was then programmed using the following values:
radius: 12.5 mm
frequency: 10.0 rad/s
initial temperature: 40° C.
final temperature: 250° C.
step size: 5° C./min
strain: 5%
ramp rate: 5
measurement time: 30 s

The viscosities of the polymers in the molten state at 180° C. and 200° C. are recorded in Table 3.

TABLE 3

| | Melt Viscosity | Melt Viscosity |
|---|---|---|
| | at 180° C. | at 200° C. |
| Sample | (Pa · s) | (Pa · s) |
| 1A1 | 3 | 0.8 |
| 1A2 | 34.5 | 2.0 |
| 1A3 | 122.5 | 44 |
| 1B1 | 3.75 | 08 |
| 1B2 | 9 | 4 |
| 1B3 | 56 | 5.5 |
| 1C1 | 2.6 | 1.9 |
| 1C2 | 18.9 | 7.7 |
| 1C3 | 77 | 19 |
| 1D1 | 0.7 | 0.3 |
| 1D2 | 5 | 3 |
| 1D3 | 15 | 5 |
| 1D4 | 95 | 12 |
| 1E | 174 | 34 |

### Example 2

Prepolymer 1 was synthesized according to the procedure described in Example 1. A pre-calculated amount of a 50wt % solution of SUPRASEC® MPR isocyanate (Table 3) was then added to a stirred 50wt % dimethylacetamide solution of Prepolymer 1 at 87° C. under nitrogen and the reaction continued for 3 hours. In the case of Polymer 2A, a dimethylacetamide solution of 6-methylisocytosine was added and the resultant reaction mixture heated with stirring at 87° C. for 3 hours. After cooling, the polymer was isolated by casting at 50° C. in vacuo. The following table 4 gives the weight composition.

TABLE 4

| | | pbw SUPRASEC | |
|---|---|---|---|
| | | MPR | |
| Sample | Pbw PPG2000 | isocyanate | pbw melso |
| 2A | 83.7 | 14.8 | 1.5 |
| 2B | 83.7 | 16.3 | 0 |

### Example 3

Prepolymer 3 was prepared by stirring a mixture of 78.6 pbw of a polyadipate ester (DALTOREZ P765 ester) having a nominal functionality of 2 and nominal MW 2200 together with 21.4 pbw SUPRASEC MPR isocyanate at 87° C. under nitrogen for three hours. After cooling, the prepolymer was stored as a masterbatch under nitrogen.

A pre-calculated amount of 1,4-butanediol (50wt % solution in dimethylacetamide) was added dropwise over a period of 20 minutes to a known amount of a stirred 50wt % dimethylacetamide solution of the prepolymer at 87° C. under nitrogen and the heating/stirring were maintained for a further 3 hours. A dimethylacetamide solution of the desired end-capping compound was added to the stirred reaction mixture at 87° C. and the reaction conditions were maintained for a further 3 hours. After cooling, the TPU or TRPU was isolated by casting at 80° C. in an oven. The formulations of the resultant TPUs and TRPUs are given in Table 5.

TABLE 5

| | End-Capping | pbw | | pbw End |
|---|---|---|---|---|
| Sample | Compound | Prepol. 3 | pbw BD | Group |
| 3B1 | 6-methyl | 92.7 | 2.6 | 4.7 |
| | isocytosine | | | |
| 3B2 | 6-methyl | 93.3 | 3.0 | 3.7 |
| | isocytosine | | | |
| 3B3 | 6-methyl | 93.9 | 3.3 | 2.8 |
| | isocytosine | | | |
| 3B4 | 6-methyl | 95.2 | 3.9 | 0.9 |
| | isocytosine | | | |
| 3C1 | 2-amino | 93.8 | 2.6 | 3.6 |
| | pyrimidine | | | |
| 3C2 | 2-amino | 94.1 | 3.0 | 2.9 |
| | pyrimidine | | | |
| 3C3 | 2-amino | 94.5 | 3.4 | 2.1 |
| | pyrimidine | | | |
| 3C4 | 2-amino | 95.4 | 3.9 | 0.7 |
| | pyrimidine | | | |
| 3D1 | ethoxyethoxy- | 92.4 | 2.6 | 5.0 |
| | ethanol | | | |
| 3D2 | ethoxyethoxy- | 93.0 | 3.0 | 4.0 |
| | ethanol | | | |
| 3D3 | ethoxyethoxy- | 93.6 | 3.4 | 3.0 |
| | ethanol | | | |
| 3D4 | ethoxyethoxy- | 95.1 | 3.9 | 1.0 |
| | ethanol | | | |
| 3E | None | 95.7 | 4.3 | 0.0 |

Tensile testing was performed at ambient temperature and a cross-head speed of 100 mm/minute on solvent-cast tensile specimens of type S2 (norm DIN53504; 0.5 mm thickness). The results of these tests are recorded in Table 6.

TABLE 6

| | | Stress | | | |
|---|---|---|---|---|---|
| | Elongation | at | Stress at | Stress at | Stress at |
| | at break | break | 100% | 200% | 300% |
| Sample | (%) | (Mpa) | elongation | elongation | elongation |
| 3B1 | 914.39 | 4.88 | 2.41 | 2.76 | 3 |
| 3B2 | 815.8 | 11.41 | 3.04 | 3.67 | 4.31 |
| 3B3 | 869.07 | 17.2 | 3.21 | 3.68 | 4.57 |
| 3B4 | 829.2 | 18.16 | 2.95 | 3.86 | 4.64 |
| 3B5 | 785.65 | 21.83 | 2.88 | 3.53 | 4.35 |
| 3C1 | 913.08 | 4.98 | 2.21 | 2.71 | 3.14 |
| 3C2 | 836.31 | 16.64 | 2.58 | 3.2 | 4.02 |
| 3C3 | 852.2 | 17.91 | 2.55 | 3.19 | 4.08 |
| 3C4 | 803.54 | 26.63 | 3.01 | 3.82 | 5.05 |
| 3C5 | 877.19 | 16.78 | 2.64 | 3.22 | 3.96 |
| 3C6 | 756.46 | 3.42 | 1.99 | 2.38 | 2.70 |
| 3D1 | 867 | 5.52 | 2.3 | 2.69 | 3.13 |
| 3D2 | 801.65 | 4.94 | 2.16 | 2.85 | 3.29 |
| 3D3 | 713.39 | 28.63 | 2.93 | 3.83 | 5.06 |
| High MW | 715 | 31.18 | 2.88 | 3.71 | 4.96 |

Rotational Dynamic Shear (RDS) rheometry was performed on solvent-cast discs (12.5 mm radius; 1 mm thickness) in temperature sweep mode according to the conditions described in Example 1. The viscosities of the polymers in the molten state at 170° C., 180° C. and 200° C. are recorded in Table 7.

TABLE 7

| | Melt Viscosity | Melt Viscosity |
|---|---|---|
| Sample | at 180° C. (Pa · s) | at 200° C. (Pa · s) |
| 3B1 | 34 | 11 |
| 3B2 | 147 | 20 |
| 3B3 | 550 | 89 |
| 3B4 | 46 | 45 |
| 3B5 | 1500 | 160 |
| 3C1 | 200 | 83 |
| 3C2 | 1216 | 413 |
| 3C3 | 1200 | 351 |
| 3C4 | 2026 | 903 |
| 3C5 | 1230 | 440 |
| 3C6 | 85 | 17 |
| 3D1 | 210 | 46 |
| 3D2 | 225 | 59 |
| 3D3 | 3400 | 1335 |
| 3E | 2500 | 910 |

### Example 4

Several of the polymers according the invention of Example 1 were tested as adhesives to bond steel to steel. To that aim lap shear test specimen were produced in the following manner. Stainless steel test plates of material type 1.4301 with dimensions of 100×25×1.5 mm were obtained from Rochell GmbH, Moosbrunn, Germany. Prior to use the test plates were degreased with acetone. The test plates were put on a hot plate, which had a temperature of 150° C. for at least 2 minutes to increase the temperature of the test plates. In the mean time some polymer was heated above its flow point. To that aim approximately 10 gram of polymer was put in a 125 mL glass jar and heated for at least 15 minutes using an oil bath at a temperature of 200° C. A sufficient amount of molten polymer was brought onto a test plate with a metal spatula to slightly overfill the 25×25×0.3 mm joint of the bond. The joint was assembled by positioning the test plates with 25 mm overlap. Subsequently, the test plates were slightly pressed together and clamped for about 15 minutes using a universal double clip. For each polymer six specimens were prepared. The lap joint test specimens were conditioned in the lab for at least 2 weeks prior for physical testing. The tensile strength was determined at a crosshead speed of 50 mm/min. and was calculated from the measured tensile force divided by the overlap area. For each series the average value of the tensile strength, its standard deviation and the failure mode were reported and given in Table 8.

TABLE 8

| | Tensile | Standard | Mode of |
|---|---|---|---|
| Polymer | strength (Mpa) | deviation (%) | failure |
| 1A1 | 2.9 | 25 | cohesive |
| 1A3 | 2.7 | 20 | adhesive |
| 1B1 | 2.1 | 20 | cohesive |
| 1B2 | 2.5 | 25 | partially co- |
| | | | and adhesive |
| 1B3 | 2.7 | 20 | partially co- |
| | | | and adhesive |
| 1C1 | 2.5 | 20 | partially co- |
| | | | and adhesive |
| 1C2 | 3.1 | 25 | adhesive |
| 1C3 | 3.4 | 30 | adhesive |

### Example 5

In this experiment, a series of polymers were tested which were not according to the invention. These polymers were applied in the same manner as described in Example 4 to prepare the steel/steel lap joints. The results are given in Table 9.

TABLE 9

| | Tensile | Standard | Mode of |
|---|---|---|---|
| Polymer | strength (MPa) | deviation (%) | failure |
| 1D2 | 1.2 | 15 | cohesive |
| 1D3 | 1.0 | 30 | cohesive |
| 1D4 | 2.3 | 15 | adhesive |
| 1E | 1.9 | 40 | adhesive |

### Example 6

In this experiment a polymer was taken which was not according to the invention. Polymer 2A was applied in the same manner as described in Example 4 to prepare the steel/steel lap joints. The lap joints thus prepared had no mechanical strength and over time the test plates came apart under gravity.

### Example 7

Table 10 shows the materials used in Examples 7 and 8.

TABLE 10

| | |
|---|---|
| Amino-functional | 6-methylisocytosine |
| organic powder | |
| Polyol (polyester) | polybutyleneglycolethyleneglycoladipate |
| | (ethyleneglycol:butyleneglycol molar |
| | ratio = 1:1; OHv = 56 mg/gKOH) |
| Isocyanate | methylenediphenylenediisocyanate |
| | (hereinafter “MDI”) (98% 4,4′isomer and |
| | 2% 2,4isomer) |
| Chain Extender | 1,4-butanediol |
| Catalyst | bismuth sulphate |

The materials of Example 7, 1A-1D, were prepared using a Brabender Plasticorder twin-screw mixing chamber, having counter-rotating screws, with a capacity of 55 g as the bulk reaction vessel. The reaction chamber of the Brabender Plasticorder was preheated to a temperature of 180° C. and the screw speed was set at 110 rpm.

The reaction mixture was pre-mixed according to the following procedure. First, the powdered solids 6-methylisocytosine were weighed into a cardboard cup. 1,4-butanediol, poly(ethyleneglycolbutyleneglycoladipate) and MDI were subsequently added. The mixture was mixed for 30 seconds at 4,000 rpm with a Heidolph Mixer, and then bismuth sulpahate was added. The mixing continued for an additional 15 seconds at 4,000 rpm. The reaction mixture was then poured into the pre-heated 180° C. reaction chamber of the Brabender Plasticorder, and-the mixture was agitated at a screw speed of 110 rpm. During the reaction the measured torque in the barrel increased substantially, and the reaction was allowed to proceed until a stable plateau torque value had been reached. It took between one and four minutes for this to occur. The material was then allowed to cool to room temperature under quiescent conditions. It took between one and fifteen mintues for this to occur.

1Hnmr spectroscopy was used to determine the relative mole % of reacted and unreacted 6-methylisocytosine (JEOL 270GSX Specttomer; 270 MHz; d6-DMSO; measured by integration 6-methyl resonance of converted (5.9 ppm) versus unreacted (5.4 ppm) 6-methylisocytosine). The chemical shift of this proton for unreacted 6-methylisocytosine was known via by 1Hnmr spectroscopy of this compound; precedent for the chemical shift assignment of the converted compound is found in “Co-operative Multiple Hydrogen Bonding in Supramolecular Chemistry”, Felix H Beijer, PhD Thesis, University of Eindhoven, 1998. Tables 11 & 12 show the formulations and percent conversion of 6-methylisocytosine to supramolecular end groups for materials, based upon two different particle size distributions of milled 6-methylisocytosine powder. Unmilled 6-methylisocytosine has a very broad particle size distribution (d₁₀₀=2188, d₉₇=954, d₇₅=360, d₅₀=91, d₂₅=6.6, d₁₀=3.3 micron) and gave conversion levels of less than 20 mole percent.

TABLE 11

| Material | Wt % | Wt % 6- | Wt % 1,4- | Wt % | Wt % |
|---|---|---|---|---|---|
| Code | MDI | methylisocytosine | butanediol | polyester | Cat |
| 1A | 20.5 | 1.4 | 3.9 | 74.2 | 0.05 |
| 1B | 20.6 | 0.6 | 4.2 | 74.6 | 0.05 |
| 1C | 24.1 | 1.2 | 5.5 | 69.2 | 0.05 |
| 1D | 24.2 | 0.65 | 5.6 | 69.55 | 0.05 |

TABLE 12

| | | | | | | | Percent mole |
|---|---|---|---|---|---|---|---|
| | Particle Size Distribution of 6- | | | | | | conversion of |
| Material | methylisocytosine (micron) | | | | | | 6- |
| Code | d₁₀₀ | d₉₇ | d₇₅ | d₅₀ | d₂₅ | d₁₀ | methylisocytosine |
| 1A | 51 | 40 | 25 | 16 | 10 | 5 | 60 |
| 1B | 51 | 40 | 25 | 16 | 10 | 5 | 75 |
| 1C | 10 | 7 | 3.8 | 2.4 | 1.5 | 0.8 | 91 |
| 1D | 10 | 7 | 3.8 | 2.4 | 1.5 | 0.8 | 95 |

### Example 8

Materials with the formulations given in Table 13 were synthesized using a Berstorff 25 mm twin-screw extruder, having co-rotating screws, and an output of 15 kg/hr. The materials were made by premixing milled isocytosine with the polyester, 1,4-butanediol and catalyst (bismuth sulphate) for 10 minutes at 5000 rpm using a high shear stirrer (Cowles Blade). The milled 6-methylisocytosine had a particle distribution equal to that of the milled isocytosine of materials 1C and 1D of Example 7. This mixture was then fed into the throat of the twin-screw extruder at a controlled rate together with the MDI and polymerized in the extruder barrel under the conditions given in Table 14. Following reaction, the materials were cooled in a water bath and then palletized. The mole percent conversion of 6-methylisocytosine to the desired supramolecular end group and the tensile properties of injection-molded samples of these materials are given in Tables 15A and 15B.

TABLE 13

| | Theoretical | | | Wt % | | |
|---|---|---|---|---|---|---|
| | Isocyanate | Wt % | Wt % 6- | 1,4- | Wt % | |
| Material | Index (%) | MDI | methylisocytosine | butanediol | polyester | Wt % Cat. |
| 2A (98) | 98 | 23.39 | 0.47 | 5.66 | 70.25 | 0.025 |
| 2A (100) | 100 | 23.87 | 0.47 | 5.63 | 69.91 | 0.025 |
| 2A (102) | 102 | 24.35 | 0.47 | 5.60 | 69.58 | 0.025 |
| 2B (98) | 98 | 23.29 | 0.70 | 5.54 | 70.34 | 0.025 |
| 2B (100) | 100 | 23.77 | 0.69 | 5.52 | 70.00 | 0.025 |
| 2B (102) | 102 | 24.24 | 0.69 | 5.49 | 69.66 | 0.025 |

TABLE 14
Barrel Temperature Profile (° C.) from feed to exit die*

| Zone | Zones | Zone | Zone | Zone | Zone | Zone | Zones | |
|---|---|---|---|---|---|---|---|---|
| 1 | 2-3 | 4 | 5 | 6 | 7 | 8 | 9-12 | Die |
| 150 | 225 | 215 | 205 | 200 | 190 | 180 | 170 | 185 |

*Screw Speed 150 rmp; Output Rate 15 kg/hr.

TABLE 15A

| | Theoretical | Mole % | | |
|---|---|---|---|---|
| | isocyanate | Conversion | Tensile | Tensile Stress |
| | Index | of 6- | Strength^{b} | at 100% Strain^{b} |
| Material | (%) | methylisocytosine^{a} | (MPa) | (MPa) |
| 2A(98) | 98 | 95 | NM | NM |
| 2A(99) | 99 | NM | 28 | 3.3 |
| 2A(100) | 100 | 99 | 32 | 3.6 |
| 2A(102) | 102 | 100 | 42 | 3.3 |
| 2B(98) | 98 | 94 | NM | NM |
| 2B(99) | 99 | Not | 18 | 3.0 |
| | | measured | | |
| 2B(100) | 100 | 100 | 19 | 3.5 |
| 2B(102) | 102 | 100 | 31 | 3.0 |

NM means Not Measured
^{a}Measured by ¹Hnmr (JEOL 270GSX Spectrtomer; 270 MHz; d₆-DMSO; measured by integration methyl resonance of converted (5.9 ppm) versus unreacted (5.4 ppm) 6-methylisocytosine).
^{b}Measured at 1000 mm/min on S2-type tensile specimens.

TABLE 15B

| | Tensile | Tensile | |
|---|---|---|---|
| | Stress | Stress | Melt Flow |
| | at 200% | at 300% | Index |
| | Strain^{b} | Strain^{b} | @180° C./10 kg |
| Material | (MPa) | (MPa) | (g/10 min) |
| 2A(98) | NM | NM | NM |
| 2A(99) | 4.4 | 5.8 | 172 |
| 2A(100) | 4.8 | 6.3 | 138 |
| 2A(102) | 4.5 | 5.9 | 71 |
| 2B(98) | NM | NM | NM |
| 2B(99) | 3.9 | 5.0 | 429 |
| 2B(100) | 4.5 | 5.6 | 255 |
| 2B(102) | 4.0 | 5.2 | 165 |

NM means Not Measured
^{a}Measured by ¹Hnmr (JEOL 270GSX Spectrtomer; 270 MHz; d₆-DMSO; measured by integration methyl resonance of converted (5.9 ppm) versus unreacted (5.4 ppm) 6-methylisocytosine).
^{b}Measured at 1000 mm/min on S2-type tensile specimens.

Tables 15A and 15B demonstrate that conversion of 6-methylisocytosine to the supramolecular end group is high for all of the materials and that the conversion efficiency approaches 100% as the isocyanate index increases to 100%. All samples melt and flow readily as shown by the high melt flow indices at 180° C.

The above examples show, among others, that the TPUs according to the invention having a molecular weight below 5000 are very interesting as the melt viscosity of these TPUs is relatively low at 180° C. and varies from 2 to 30 Pa·s.

What is claimed is:

1. A process comprising:
a. mixing at least one polyol, a chain extender, a diisocyante, an amino-functional organic powder, and optionally a catalyst, to form a mixture, and wherein the amino-functional organic powder has an average particle size of less than about 100 microns; and
b. heating the mixture to a temperature between about 100° C. and about 250° C.

2. The process of claim 1, wherein the amino-functional organic powder is selected from the group consisting of 2-aminopyrimidine, isocytosine, 6-alkylisocytosine, 6-methylisocytosine, 2-aminopyridine, 5-amino-uracil 6-tridecylisocytosine, 6-phenyl-isocytosine, 2-amino-6-(3-butenyl)-4-pyrimidone, p-di-(2-amino-6-ethyl-4-pyrimidone)benzene, 2-amino 4-pyridone, 4-pyrimidone 6-methyl-2-amino-4-pyrimidone, 6-ethyl-2-amino-4-pyrimidone, 6-phenyl-2-amino-4-pyrimidone, 6-(p-nitrophenyl)isocytosine, 6-(trifluoromethyl)isocytosine and their mixtures.

3. The process of claim 2, wherein the amino-functional organic powder is selected from the group consisting of 2-aminopyrimidine, 5-aminouracil, isocytosine 6-alkylisocytosine, and 6-methylisocytosine.

4. The process of claim 3, wherein the amino-functional organic powder is 6-methylisocytosine.

5. The process of claim 4, wherein 97 percent of the 6-methylisocytosine has a particle size less than about 10 microns.

6. The process of claim 4, wherein the total weight of the mixture comprises from about 0.05 to about 2.5 weight percent 6-methylisocytosine.

7. The process of claim 6, wherein the total weight of the mixture comprises from about 0.5 to about 2 weight percent 6-methylisocytosine.

8. The process of claim 1, further comprising cooling the mixture to about room temperature, wherein the molar percent conversion of the amino-functional organic powder is between about 40 to about 100 percent.

9. The process of claim 8, wherein the molar percent conversion of the amino-functional organic powder is between about 70 to about 100 percent.

10. The process of claim 9, wherein the molar percent conversion of the amino-functional organic powder is between about 90 to about 100 percent.

11. The process of claim 1, wherein less than about 10% by weight of the mixture is solvent.

12. The process of claim 11, wherein less than about 0.5% by weight of the mixture is solvent.

13. The process of claim 1, further comprising prepolymizing the at least one polyol and the diisocyante.

14. The process of claim 1, wherein the isocyanate, the at least one polyol, the chain extender, and optionally the catalyst are mixed together, and the amino-functional organic powder is mixed subsequently.

15. The process of claim 1, wherein the catalyst is selected from the group consisting of tin compounds, such as a tin salt of a carboxylic acid, for example dibutyltin dilaurate, stannous acetate and stannous octoate; amines, such as dimethylcyclohexylamine and triethylene diamine; and bismuth sulphate.

16. The process of claim 1, wherein the chain extender is selected from the group consisting of ethylene glycol, diethylene glycol, butanediol, triethylene glycol, tripropylene glycol, 2-hydroxyethyl-2′-hydroxypropylether, 1,2-propylene glycol, 1,3-propylene glycol, PRIPOL® diol(commercially available from Uniquema, Gouda, NL), dipropyl glycol, 1,2-, 1,3- and 1,4-butylene glycols, 1,5-pentane diol, bis-2-hydroxypropyl sulphide, bis-2-hydroxyalkyl carbonates, p-xylylene glycol, 4-hydroxymethyl-2,6-dimethyl phenol, 1,2-, 1,3- and 1,4-dihydroxy benzenes, and 1,4-butanediol.

17. The process of claim 1, wherein the polyol is selected from the group consisting of a polyether, a polyether diol such as ethylene oxide, propylene oxide, butylene oxide or tetrahydrofuran, a polyester, hydroxyl terminated polythioethers, polyamides, polyesteramides, polycarbonates, polyacetals, polyolefins and polysiloxanes, mixtures thereof, and combinations thereof.

18. The process of claim 1, wherein the isocyanate is selected from the group consisting of 2,4′diphenylmethane diisocyanate, 2,2′ diphenylmethane diisocyanate, 4,4′ diphenylmethane diisocyanate, diphenylmethane diisocyanates, mixtures thereof, and oligomers thereof, wherein the functionality of the isocyante is greater than 2.

19. The process of claim 1 further comprising producing the polymer on a commercial scale.
